(19) United States
(12) Patent Application Publication
(10) Pub. No.: US 2014/0130929 A1
(43) Pub. Date: May 15, 2014

(54) SEAMLESS HELICALLY CORRUGATED TUBES AND METHODS OF MANUFACTURE

(71) Applicant: Euramax International, Inc., Norcross, GA (US)

(72) Inventors: Benjamin Randolph Elliott, Chattanooga, TN (US); Eric Michael Boettner, Cleveland, TN (US); Christopher Turner, Cleveland, TN (US)

(73) Assignee: Euramax International, Inc., Norcross, GA (US)

(21) Appl. No.: 14/073,248

(22) Filed: Nov. 6, 2013

Related U.S. Application Data
(60) Provisional application No. 61/723,364, filed on Nov. 7, 2012.

(51) Int. Cl. F16L 11/11

(52) U.S. Cl. CPC F16L 11/11
USPC 138/121; 264/209.2

(57) ABSTRACT

Flexible, helically corrugated, seamless pipes and tubular conduits of indeterminate length. In some embodiments, these pipes or conduits are formed by a continuous corrugating process on a corrugator. In some embodiments, the pipes are collapsible and are configured to remain in the collapsed and un-collapsed state without the application of external force. Also disclosed are helical tubes include corrugations that follow a counterclockwise path and corrugations that follow a clockwise path. Also disclosed are dual helical tubes with helical corrugations configured such that a portion of each corrugation follows a counterclockwise rotation and another portion of the corrugation follows a clockwise rotation.

### RELATED APPLICATIONS

This application claims the benefit of U.S. Provisional Application No. 61/723,364 filed on Nov. 7, 2012 and titled “Seamless Helical Collapsible Pipe and Method of Manufacture,” the contents of which are incorporated herein by reference.

### FIELD OF THE INVENTION

This application relates to flexible pipes and tubular conduits, as well as methods of manufacturing such devices.

### BACKGROUND

Flexible pipes and tubular conduits with corrugations can be made by extruding a polymeric melt between sets of female molds making up a continuous surface and forming the tube to the shape of the molds. This process is typically referred to as a continuous corrugating process. The corrugations in the pipe/tube may be either annular or helical in design. When forming a pipe using a continuous corrugation process, it is desirable that the length of the molds be evenly divisible by the pitch of the corrugations so that all molds are identical. Typically, the molds begin and end at the major diameter (peak) of the profile of the pipe to avoid thin sections of the mold that are susceptible to damage. When manufacturing molds for a continuous corrugation process, it is less expensive and time consuming to machine annular profiles and shapes, as opposed to helical, that are contained in a single mold set.

With a collapsible pipe, the radius at the minor diameter (valley) of the profile is typically formed as small as possible to facilitate bending. Any defect at the valley of the profile makes the conduit more susceptible to un-collapsing unless external force is applied to restrain it. Additionally, defects at this point add to stress concentrations and often result in fracture during the flexing of the conduit.

In the continuous corrugating process, a parting line is created at the interface of each pair of molds. Due to machine design and manufacturing tolerances, a misalignment between molds pairs often occurs at this parting line. Therefore, the minor diameter of the profile is typically arranged so that it does not align with this parting line to minimize the possibility that a misalignment would cause a defect that will result in fracture and/or failure of the product to remain in the collapsed state. Additionally, placing the minor diameter on the mold edge causes thin sections of the mold that are easily damaged, increasing the likelihood of defects in the finished article. Misalignment or defects located at the major diameter (peak) of the conduit are thought to have relatively little effect.

In the continuous corrugating process, a parison is expanded to conform to the shape of the female mold pairs. As the parison expands, the wall thickness decreases until it contacts the mold surface. As such, the wall sections at the minor diameter where the parison contacts first are thicker and become incrementally thinner up to the major diameter where the parison contacts last.

It is also known to produce a corrugated, flexible pipe or tubular conduit by adhesive bonding a polymeric extrudate while helically wrapping in an overlapping pattern. In contrast to the continuous corrugating process, a profile is extruded and wound in an overlapping manner in the helical wrapping method. To form the article, the article being produced rotates with an angular velocity determined by the diameter and pitch of the corrugations. The thickness and shape of this profile can be varied and used to control the wall thickness of the finished article. Additionally, the location and width of the overlap can be used to create a corrugation profile with thin wall sections at the major and minor diameters while having thick wall sections elsewhere. Typically, a collapsible, helically wrapped pipe includes thin wall sections at the minor diameters (valleys) to facilitate collapse, and thick wall sections in the legs for proper functionality. In some cases, the pipe is double wrapped at the peaks for stability. Such a configuration cannot be formed using the continuous corrugation process and therefore collapsible helically corrugated pipes and tubular conduits have been produced by helical wrapping methods in the past. Adhesive bonding of a polymeric extrudate while helically wrapping in an overlapping pattern produces an article with a bonded seam that runs in a helical manner along its length.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

Disclosed are flexible, helically corrugated, seamless pipes and tubular conduits of indeterminate length that are configured to remain in the collapsed and un-collapsed state without externally applied force. In some embodiments, these pipes or conduits are formed by a continuous corrugating process on a corrugator. In some embodiments, the pipes are collapsible.

In some embodiments, the pipes or conduits are molded in shapes other than helical corrugations or plain cylinders that are contiguous to the corrugations. This allows for the manufacture of products with integrated cuffs and fittings with shapes that are not restricted to symmetrical proportions. In some embodiments, the collapsible pipes and tubular conduits are of indefinite length and have non-cylindrical bodies and the corrugation has a profile that follows a helical path that is not round such as a square or other polygonal form. In some embodiments, the pipes or tubular conduits are configured so that the force required to un-collapse the article is less than the force required to collapse it.

In some embodiments, the helical pipes or tubes have helical corrugations that have a clockwise rotation and helical corrugations that have a counterclockwise rotation. Also disclosed are dual helical tubes with helical corrugations configured such that a portion of each corrugation follows a counterclockwise rotation and another portion of the corrugation follows a clockwise rotation.

### BRIEF DESCRIPTION OF THE DRAWINGS

Illustrative embodiments of the present invention are described in detail below with reference to the following drawing figures:

FIG. 1A is a front view of a flexible, helically corrugated, collapsible seamless tube according to one embodiment.

FIG. 1B is a section view of the tube of FIG. 1A, taken along the line A-A.

FIG. 1C is a detail view of the tube of FIG. 1B, taken at inset circle A.

FIG. 2A is a front view of a flexible, helically corrugated, collapsible seamless tube with a non-cylindrical helix.

FIG. 2B is a section view of the tube of FIG. 2A, taken along the line B-B.

FIG. 2C is a perspective view of the tube of FIG. 2A.

FIG. 2D is a detail view of the tube of FIG. 2B, taken at inset circle B.

FIG. 3A is a front view of a flexible, helically corrugated, collapsible seamless tube with non-corrugated sections and integral cuffs.

FIG. 3B is a side view of the tube of FIG. 3A.

FIG. 3C is a rear view of the tube of FIG. 3A.

FIG. 4A is a front view of a flexible, annular corrugated, collapsible seamless tube in the collapsed state.

FIG. 4B is a side view of the tube of FIG. 4A.

FIG. 4C is a detail view of the tube of FIG. 4B, taken at inset circle C.

FIG. 5A is a front view of a flexible, annular corrugated, collapsible seamless tube with a complex corrugation profile.

FIG. 5B is a side view of the tube of FIG. 5A.

FIG. 5C is a detail view of the tube of FIG. 5B, taken at inset circle D.

FIG. 6 is a partial side view of a continuous, plastic, helical, collapsible tube according to another embodiment.

FIG. 7 is a partial side view of a continuous, plastic, helical, collapsible alternating helical tube according to another embodiment.

FIG. 8 is a partial side view showing a thread on helical fitting according to another embodiment.

FIG. 9 is a cut-away view showing a portion of the helical fitting of FIG. 8 connected to a helical tube.

FIG. 10A is a perspective view of a helical tube with a helical fitting positioned with respect to one another.

FIG. 10B is a perspective view of the helical tube and the helical fitting of FIG. 10A threaded together.

FIG. 11 is a side view of a collapsible dual helical tube according to one embodiment.

FIG. 12 is a side view of a non-collapsible dual helical tube according to another embodiment.

FIG. 13 is a side view of a dual helical fitting according to yet another embodiment.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Disclosed is a pipe (sometimes referred to as a tube) or tubular conduit of indeterminate length that is flexible, seamless, helically corrugated and in some embodiments collapsible such that it will remain in the collapsed and un-collapsed conditions without the application of external force. In some embodiments, the pipe is formed on a corrugator using a continuous corrugating process.

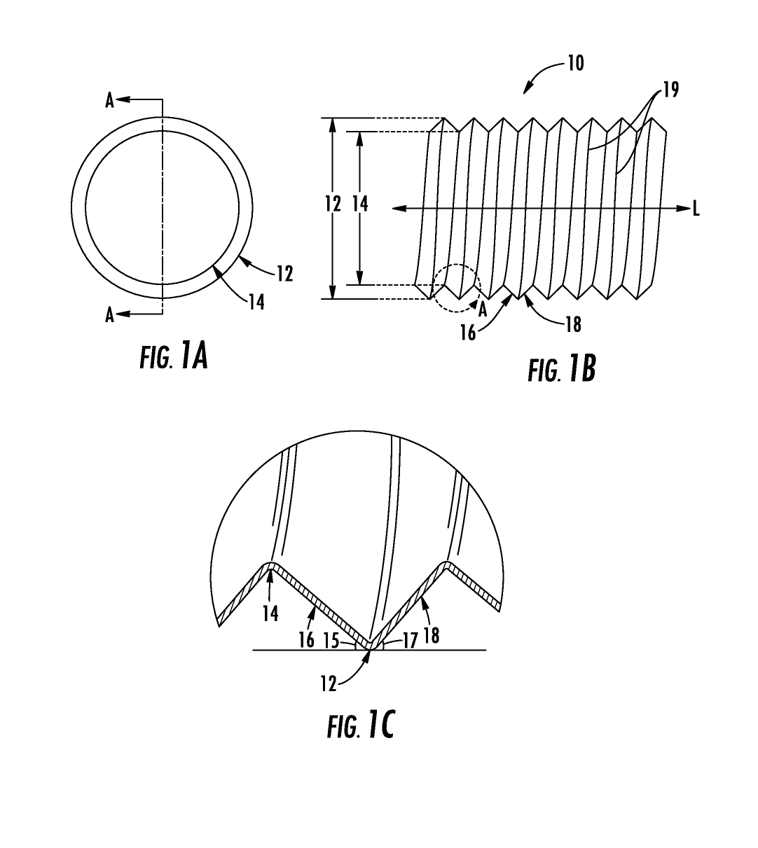

FIGS. 1A-1C depict a length of an exemplary tube or pipe 10 that is flexible, seamless, helically corrugated and collapsible. The tube 10 includes a major diameter (peak) 12, a minor diameter (valley) 14, a long profile leg 16, and a short profile leg 18. The configuration of the short profile leg 18 relative to the long profile leg 16 facilitates collapse of the tube 10. As illustrated, tube 10 has a plurality of helical corrugations 19. Helical corrugations 10 have increased hoop strength when compared to annual corrugations and prevent whistling (caused by air flow disturbance) if used in a vacuum process. The angle of the corrugations 19 may be configured to allow the tube to collapse axially (along the tube's longitudinal axis L) and remain in the collapsed state without the application of external force. In some cases, the angle 15 of the long profile leg 16 relative to the longitudinal axis L is between approximately 45 degrees and 52 degrees, and in some cases is around 45°, while the angle 17 of the short profile leg 18 relative to the longitudinal axis L is between approximately 42 degrees and 49 degrees, and in some cases is around 42°.

Tube 10 may be formed of a flexible material such as but not limited to thermoplastic and may be configured so that it may be bent into any shape while maintaining the shape of the helical corrugations. The helical corrugations 19 are illustrated in FIG. 1B as having a clockwise rotation (following a clockwise path) although some or all may have a counterclockwise rotation (follow a counteclockwise path) in other embodiments.

Tube 10 may be formed in a continuous, seamless process on a corrugator such that the corrugations 19 of tube 10 are seamless. In particular, tube 10 may be made by extruding a polymeric melt between sets of female molds forming an endless surface and forming the extrudate to the shape of the molds by fluid pressure differential. Because tube 10 is formed in a continuous corrugating process, tube 10 may have any desired length. Optionally, cuffs and fittings may be integrally molded with or separately attached to the tube if desired.

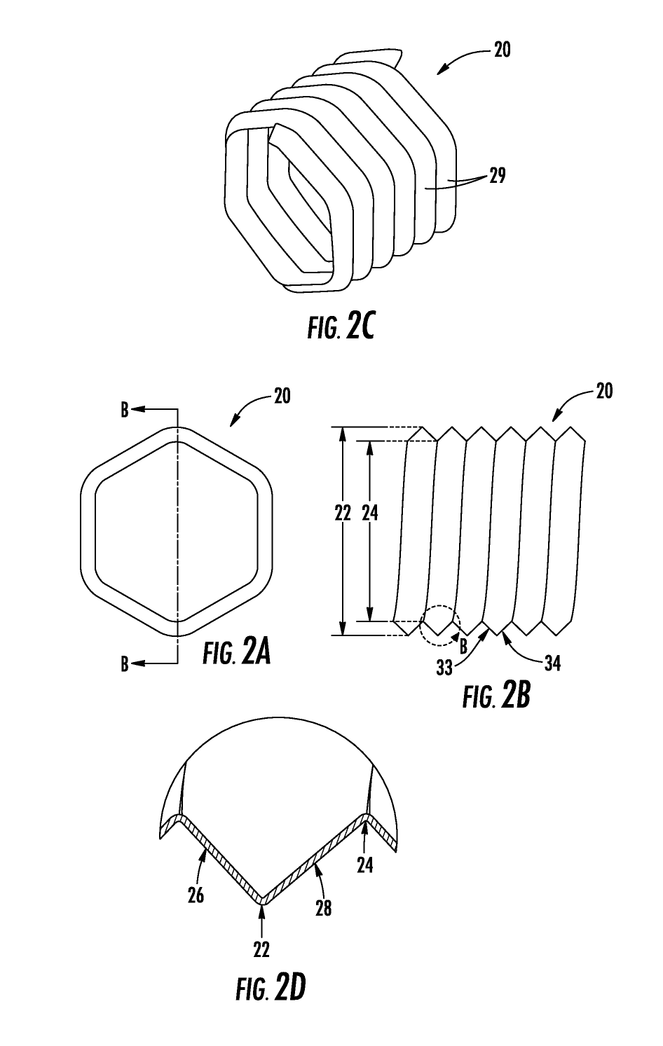

FIGS. 2A-2D illustrate a length of an exemplary tube 20 that is flexible, seamless, helically corrugated and collapsible. The helical path of the corrugations 29 of tube 20 is non-cylindrical. As illustrated, the corrugations 29 follow a hexagonal path such that the corrugations have a hexagonal cross section, although the cross section may be any suitable shape. Tube 20 includes a major diameter (peak) 22, a minor diameter (valley) 22, a long profile leg 26, and a short profile leg 28. In some cases, tube 20 is formed on a corrugator in a continuous corrugating process.

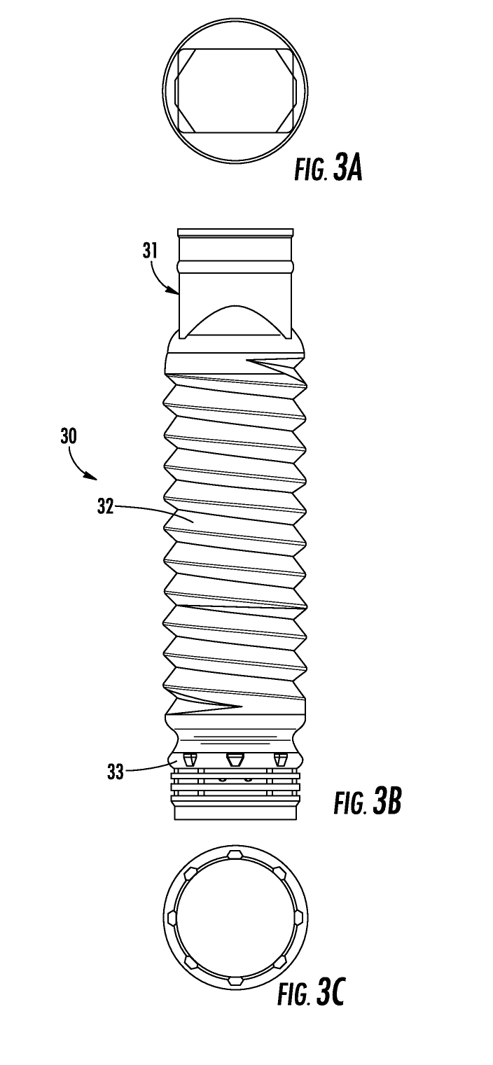

FIGS. 3A-3C depict a length of an exemplary tube 30 that is flexible, seamless, helically corrugated and collapsible. Tube 30 includes a first non-corrugated section 31 with a rectangular cross section integrally molded with a helically corrugated body 32 that is integrally molded with a second non-corrugated body 33. Tube 30 may have any suitable cross section and is not limited to rectangular. Second non-corrugated body 33 has features, such as but not limited to externally protruding barbs, for connecting to other articles. In some cases, tube 30 is formed on a corrugator in a continuous corrugating process.

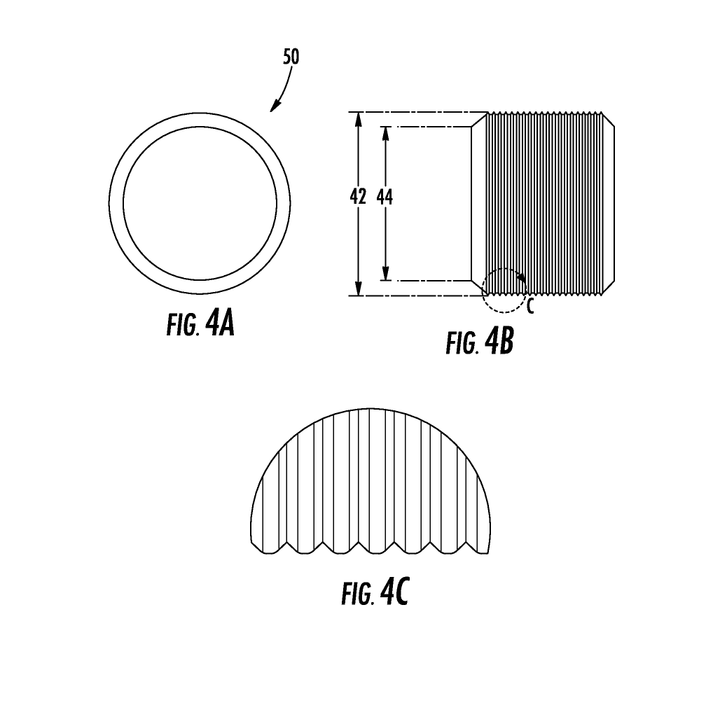

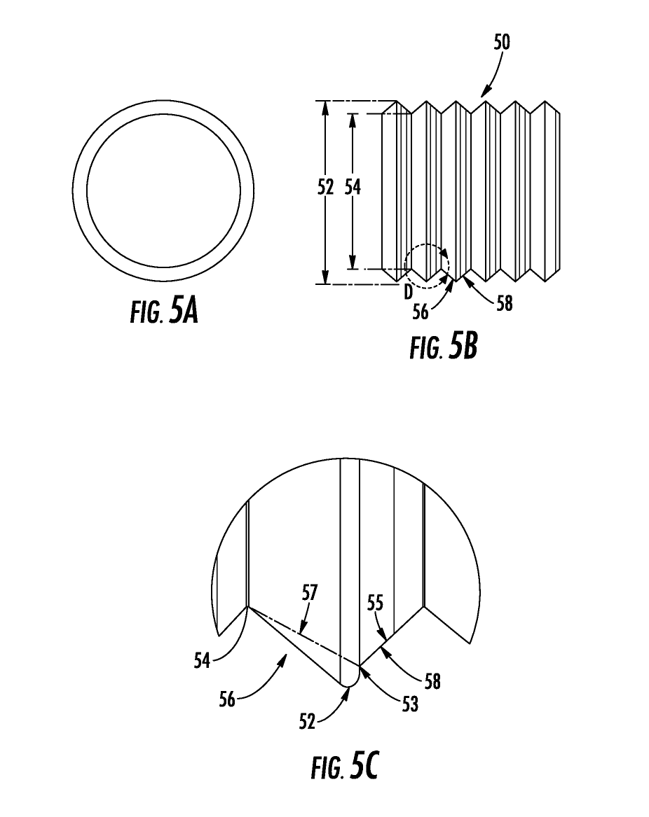

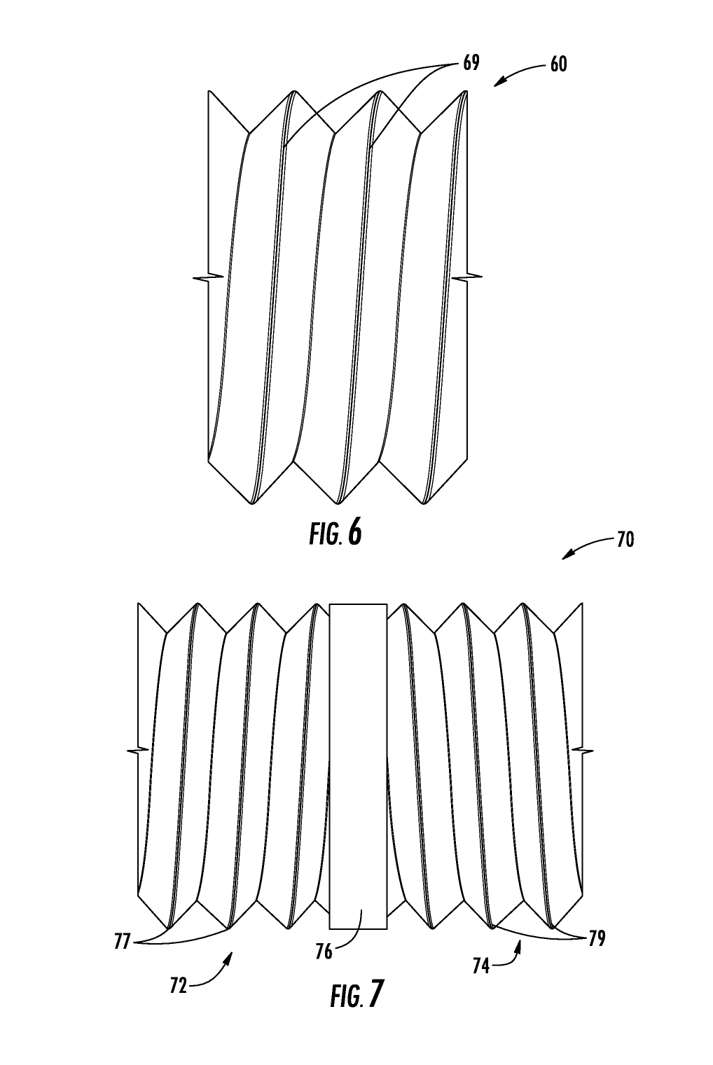

FIGS. 4A-4C depict a length of an exemplary tube 40 that is flexible, seamless, annularly corrugated and collapsible and shown in the collapsed condition. Tube 40 includes a major diameter 42 and a minor diameter 44.

FIGS. 5A-5C depict a length of an exemplary tube 50 that is flexible, seamless, annularly corrugated and collapsible and that has a complex shaped corrugation profile. Tube 50 includes a major diameter (peak) 52, a minor diameter (valley) 54, a long profile leg 56, and a short profile leg 58, a long fulcrum 57, a short fulcrum 55, and a bending point 53. Corrugation profiles of a more complex design may be made to be collapsible by providing a bending point offset from the major diameter such that there is a long fulcrum and a short fulcrum and so that the proportions and ratios of the major diameter, minor diameter, long fulcrum and the short fulcrum render the pipe collapsible. Flexible, seamless helically corrugated and collapsible pipes and tubular conduits of an indeterminate length may also be formed with complex corrugation profiles. These profiles may be formed in a continuous corrugation process.

FIGS. 6-13 illustrate various tubes according to other embodiments. These tubes may be continuous, helical, flexible and may be formed on a corrugator in a continuous corrugating process. The tubes may be collapsible or non-collapsible. In some embodiments, the tubes are formed of thermoplastic or other suitable flexible material. FIG. 6 illustrates an example of a portion of a tube 60 with helical corrugations 69 that follow a generally clockwise path.

FIG. 7 illustrates a tube 70 having a first section 72 of helical corrugations 77 configured in a counterclockwise rotation (that follow a counterclockwise path) and a second section 74 of helical corrugations 79 configured in a clockwise rotation (that follow a clockwise path) and a transition section 76 connecting first section 72 and second section 74. A tube having helical corrugations that transition from a clockwise rotation to a counterclockwise rotation is more universal in that it can be mated with other tubes, fittings, cuffs, etc. having corrugations of either counterclockwise or clockwise rotation. Moreover, the configuration lends itself to more automated collapsing.

FIG. 8 illustrates a portion of a tube 80 with an optional molded cuff 84 that is integral with a connection section 82. Cuff 84 is illustrated as having a feature (such as outwardly extending barbs 86) for connecting the tube 80 to other devices, although cuff 84 may have inwardly extending barbs or no barbs. Tube 80 may be configured to connect to other fittings, other tubes, or any other desirable product. In some embodiments, cuff 84 is a separate component that attaches to an end of tube 80 rather than being integral with tube 80.

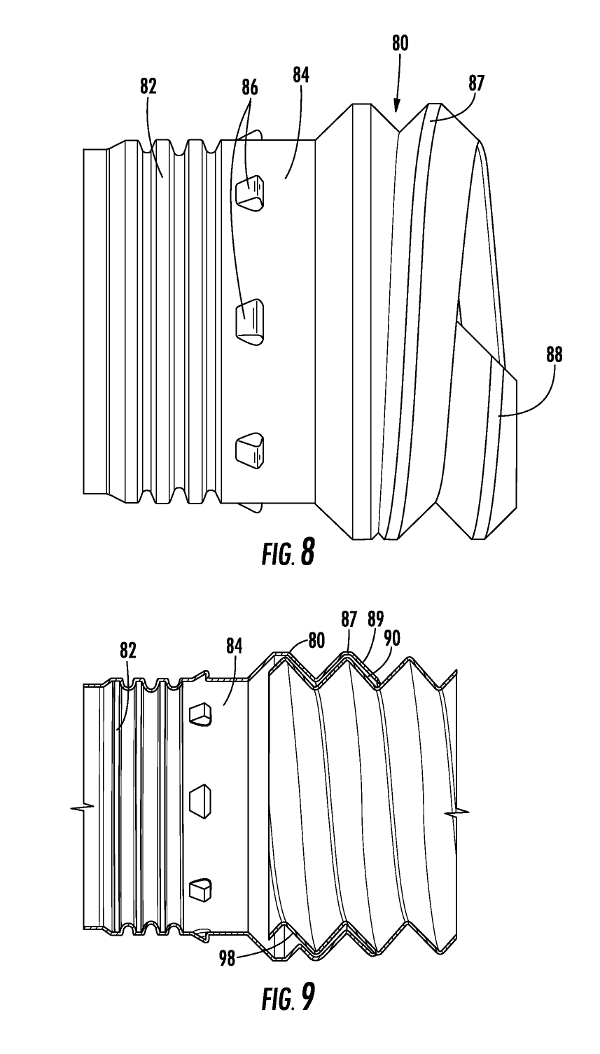

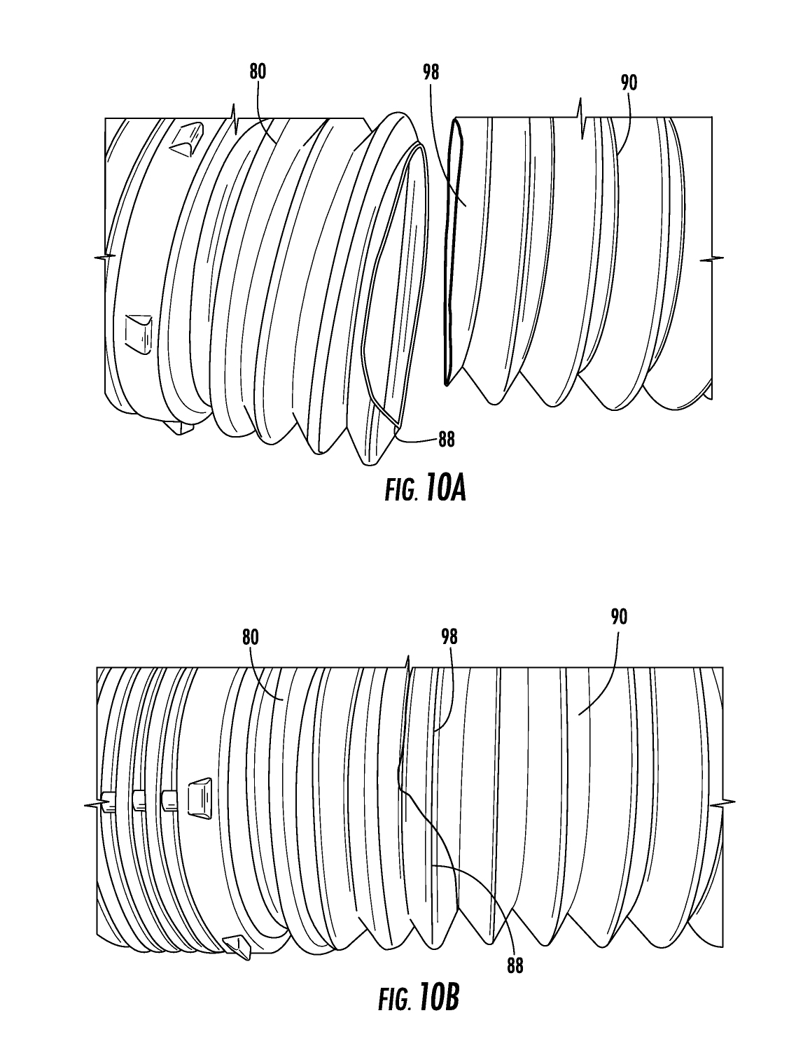

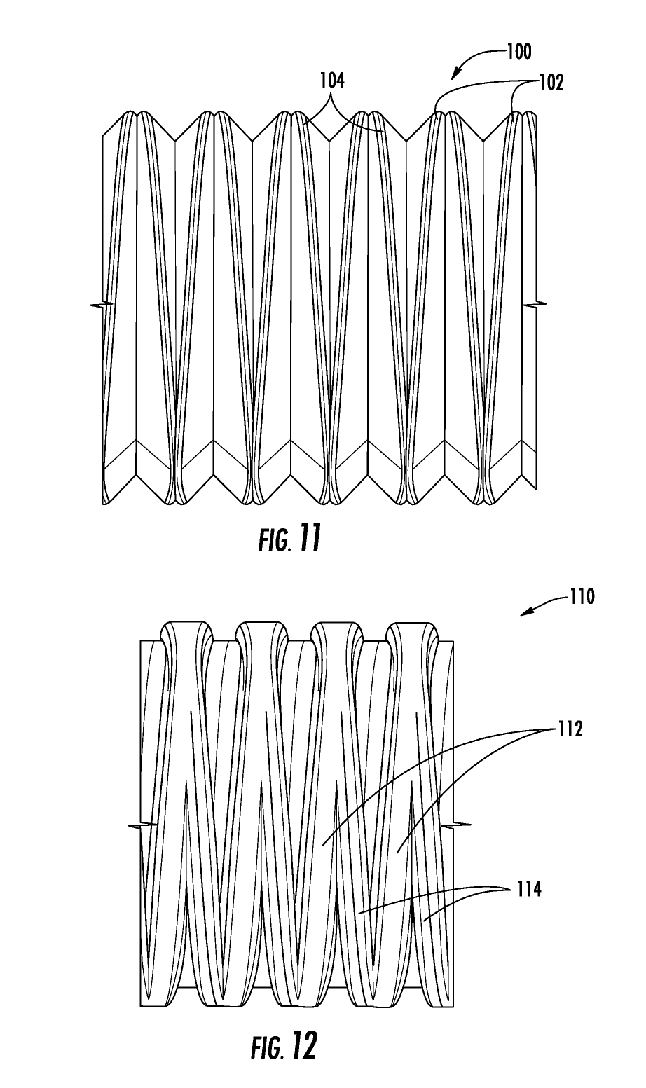

Tube 80 includes helical corrugations 87 that are configured so that an end of the tube terminates in a helical fitting 88. Helical fitting 80 is a section of the helical corrugations 87 that is slightly smaller or slightly larger than the corrugations of a corresponding helical tube (such as tube 90 shown in FIGS. 9 and 10A-10B) with which tube 80 is configured to mate. Helical corrugations 87 may be clockwise or counterclockwise in rotation to thread with a helical tube having corrugations of the same rotation.

Helical corrugations 87 of the helical fitting 88 can either thread over the corrugations of a helical fitting of the corresponding tube (such as helical fitting 98 of tube 90 as shown in FIG. 9) or thread inside the corrugations of a corresponding tube (not shown). FIGS. 10A illustrates two tubes 80 and 90 having corresponding helical fittings 88 and 98 and FIG. 10B shows the two tubes 80 and 90 with the helical fittings 99 and 98 threaded together.

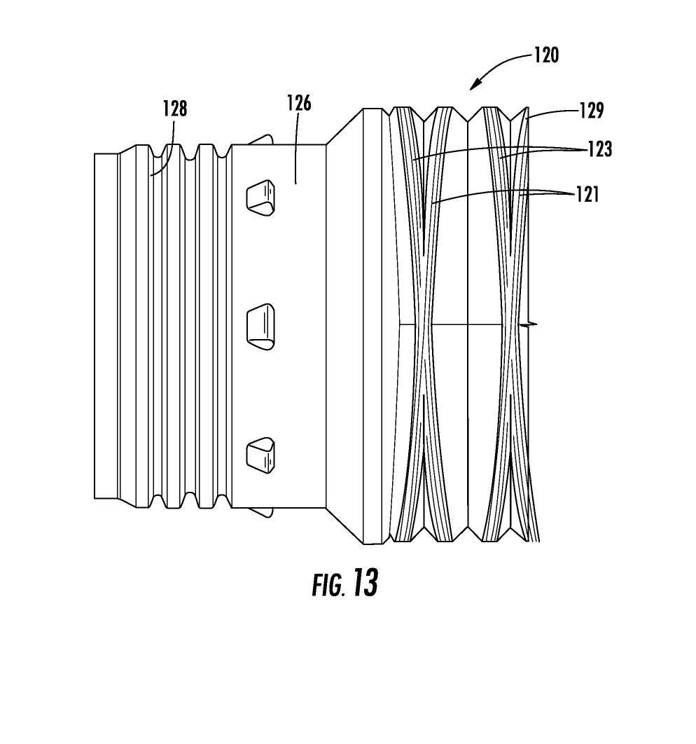

FIGS. 11-13 show various embodiments of a dual helical tube. FIG. 11 shows a dual helical tube 100 that is collapsible and that includes helical corrugations configured such that a portion 102 of the corrugation follows a clockwise rotation and another portion 104 of the corrugation follows a counterclockwise rotation. Portion 102 abuts with portion 104 to create a dual helical tube with increased hoop strength and that resists compression. The dual helical design of tube 100 acts like a spring that provides greater resistance the more the tube 100 is compressed axially.

Tube 100 may be manufactured using any suitable process, including but not limited to blow molding or a continuous corrugation process. Moreover, the angles of the corrugations may be configured to allow the tube to collapse axially and to maintain a collapsed state. For example, the short leg of the corrugations may extend at an angle of between approximately 42 degrees and approximately 49 degrees, although any suitable angle may be used. The long leg may extend at an angle of between approximately 45 degrees and approximately 52 degrees, although any suitable angle may be used. The tube 100 is formed of any suitable material, such as but not limited to thermoplastic, that is capable of being bent into any desired shape and maintaining such shape.

FIG. 12 illustrates another example of portion of a dual helical tube 110, although tube 110 is non-collapsible. As shown, tube 110 includes helical corrugations configured such that a portion 112 of the corrugation follows a clockwise rotation and another portion 114 of the corrugation follows a counterclockwise rotation. Portion 112 abuts with portion 114 to create a dual helical tube with increased hoop strength and that resists compression. Tube 110 may be manufactured using any suitable process, including but not limited to blow molding or a continuous corrugation process. Tube 110 is formed of any suitable material, including but not limited to thermoplastic, that is capable of being bent into any desired shape and maintaining such shape.

FIG. 13 illustrates a dual helical tube 120 having an optional molded cuff 126 that is integral with a connection section 126. Dual helical tube 120 includes helical corrugations configured such that a portion 121 of the corrugation follows a clockwise rotation and another portion 123 of the corrugation follows a counterclockwise rotation. Portion 121 abuts with portion 123 to create a dual helical tube with increased hoop strength and that resists compression. An end of tube 120 may terminate in a helical fitting 129, which is a section of dual helical corrugations that is either slightly larger or slightly smaller than the corrugations of a helical tube with which helical fitting 129 will thread onto or into. The helical corrugations of helical fitting 129 can either thread over the corrugations of the corresponding tube or inside the corrugations of the corresponding tube as described above. Tube 120 may be configured to connect to other fittings, other tubes, or any other desirable product. In some embodiments, cuff 126 is a separate component that attaches to an end of tube 120 rather than being integral with tube 120.

Different arrangements of the components depicted in the drawings or described above, as well as components and steps not shown or described are possible. Similarly, some features and subcombinations are useful and may be employed without reference to other features and subcombinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

That which is claimed is:

1. A tube of indeterminate length that is flexible, seamless, and collapsible, wherein the tube comprises a plurality of helical corrugations and is formed using a continuous corrugating process.

2. The tube of claim 1, wherein the tube has a long leg and a short leg, and wherein the tube leg extends at an angle that is different from the angle at which the long leg extends.

3. The tube of claim 1, wherein the helical corrugations are non-cylindrical.

4. The tube of claim 1, wherein the tube comprises a first section with helical corrugations that follow a clockwise path and a second section with helical corrugations that follow a counterclockwise path.

5. The tube of claim 4, further comprising a transition section that connects the first section with the second section.

6. The tube of claim 1, wherein an end of the tube terminates in a helical fitting configured to thread with an end of a second tube.

7. A method of forming a tube that is flexible, seamless, and collapsible and that has a plurality of helical corrugations, the method comprising:
extruding a polymeric melt between sets of female molds forming an endless surface; and
using differential pressure to form the extrudate to the shape of the molds to form the tube.

8. The method of claim 6, wherein the extruding is performed on a continuous corrugator.

9. The method of claim 6, further comprising providing a first set of female molds with cavities following a counterclockwise path and providing a second set of female molds with cavities following a clockwise path.

10. A tube that is flexible, seamless, and collapsible, wherein the tube comprises a plurality of helical corrugations and is formed using a continuous corrugating process, wherein the helical corrugations comprise a first set of corrugations that follow a clockwise path and a second set of corrugations that follow a counterclockwise path.

11. The tube of claim 10, further comprising a transition section that separates the second set of corrugations from the first set of corrugations.

12. The tube of claim 10, wherein the tube is formed of a thermoplastic material.

13. A dual helical tube comprising helical corrugations configured such that a portion of each of the corrugations follows a counterclockwise rotation and another portion of the corrugations follows a clockwise rotation.

14. The dual helical tube of claim 13, wherein the portion of the corrugations that follows the counterclockwise rotation abuts against the another portion of the corrugations that follows the clockwise rotation.

15. The dual helical tube of claim 13, wherein the tube is collapsible and wherein the abutting portions act like a spring that provides greater resistance the more the tube is compressed axially.

16. The dual helical tube of claim 13, wherein the tube is non-collapsible.

17. The dual helical tube of claim 13, wherein the tube is formed using a continuous corrugation process.

18. The dual helical tube of claim 13, wherein the tube is formed by helically wrapping.

19. The dual helical tube of claim 13, wherein an end of the tube terminates in a helical fitting configured to thread with an end of a second tube.
